(19) United States
(12) Patent Application Publication
(10) Pub. No.: US 2023/0122104 A1
(43) Pub. Date: Apr. 20, 2023

(54) Body Worn Proximity Sensing And Alerting Device

(71) Applicants: Walter Tates, Chicago, IL (US); Kim Tates, Chicago, IL (US)

(72) Inventors: Walter Tates, Chicago, IL (US); Kim Tates, Chicago, IL (US)

(21) Appl. No.: 17/504,660

(22) Filed: Oct. 19, 2021

(51) Int. Cl. G08B 21/18; G08B 3/10; G08B 6/00

(52) U.S. Cl. CPC G08B 21/182; G08B 3/10; G08B 6/00

(57) ABSTRACT

A body worn proximity sensing and alerting device for maintaining personal space includes a housing, which defines an interior space. A fastener is engaged to a first face of the housing and can selectively engage a user so that the housing is removably engaged to the user. A battery and a microprocessor are engaged to the housing and are positioned in the interior space. An alert module is engaged to the housing. A sensor is engaged to a second face of the housing. The microprocessor is operationally engaged to the battery and is communicatively engaged to the alert module and the sensor. The sensor performs proximity detection and communicates detection events to the microprocessor. The microprocessor selectively actuates the alert module to alert the user of detection events, facilitating the user in maintaining their personal space and distance from others.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to sensing and alerting devices and more particularly pertains to a new sensing and alerting device for maintaining personal space. The present invention discloses a sensing and alerting device comprising a body worn, pin-back button formatted housing, which can be affixed to an article of clothing. A proximity sensor detects when another individual comes within a defined distance of a user wearing the article of closing, whereupon a speaker and a vibrator selectively produce an audible and a vibratory alert, respectively.

### (2) Description of Related Art Including Information Disclosed Under 37 CFR 1.97 and 1.98

The prior art relates to sensing and alerting devices, which generally comprise user worn badges that alert a user when they approach a hazardous or restricted area. What is lacking in the prior art is a sensing and alerting device comprising a body worn, pin-back button formatted housing, which can be affixed to an article of clothing. A proximity sensor detects when another individual comes within a defined distance of a user wearing the article of closing, whereupon a speaker and a vibrator selectively produce an audible and a vibratory alert, respectively.

### BRIEF SUMMARY OF THE INVENTION

An embodiment of the disclosure meets the needs presented above by generally comprising a housing, which defines an interior space. A fastener is engaged to a first face of the housing and is configured to selectively engage a user so that the housing is removably engaged to the user. A battery and a microprocessor are engaged to the housing and are positioned in the interior space. An alert module is engaged to the housing. A sensor is engaged to a second face of the housing. The microprocessor is operationally engaged to the battery and is communicatively engaged to the alert module and the sensor. The sensor is configured for proximity detection and to communicate a detection event to the microprocessor. The microprocessor selectively actuates the alert module, which is configured to alert to the user of the detection event, thereby facilitating the user in maintaining their personal space and distance from others.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a body worn proximity sensing and alerting device according to an embodiment of the disclosure.

FIG. 2 is a front view of an embodiment of the disclosure.

FIG. 3 is a rear view of an embodiment of the disclosure.

FIG. 4 is a side view of an embodiment of the disclosure.

FIG. 5 is a side view of an embodiment of the disclosure.

FIG. 6 is a top view of an embodiment of the disclosure.

FIG. 7 is an in-use view of an embodiment of the disclosure.

### DETAILED DESCRIPTION OF THE INVENTION

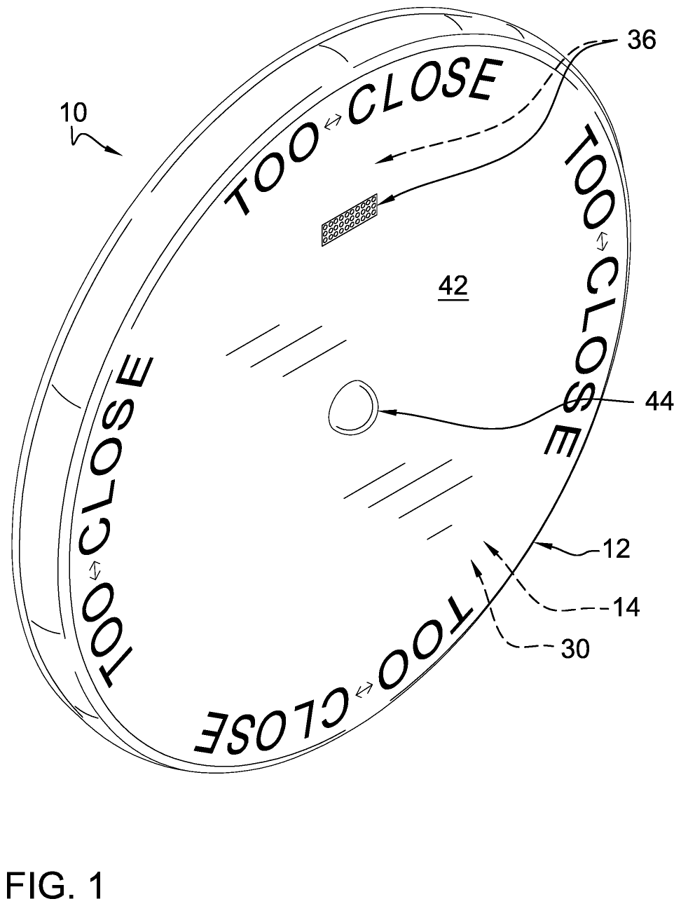

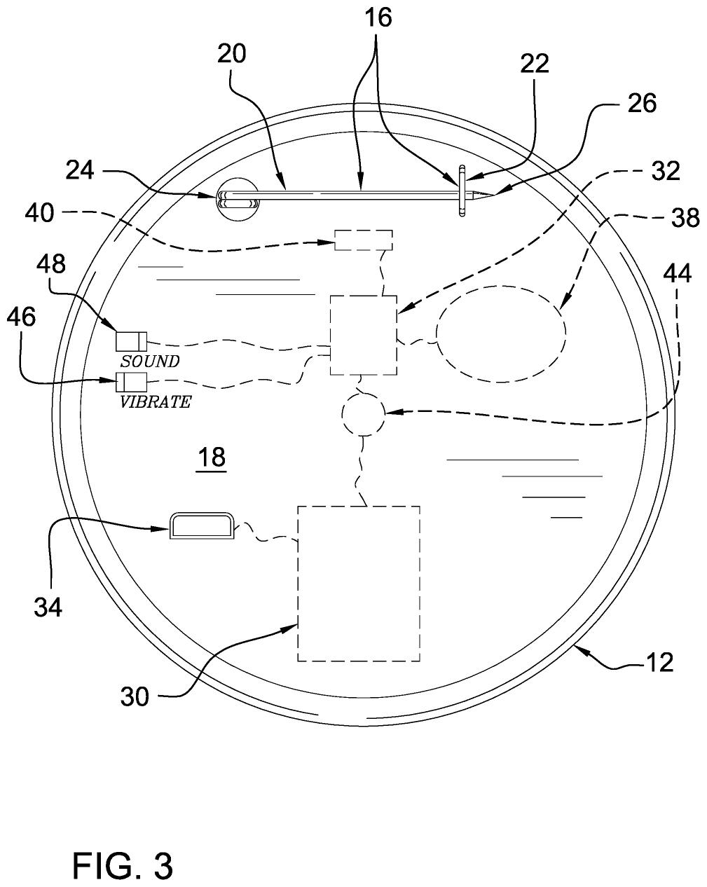

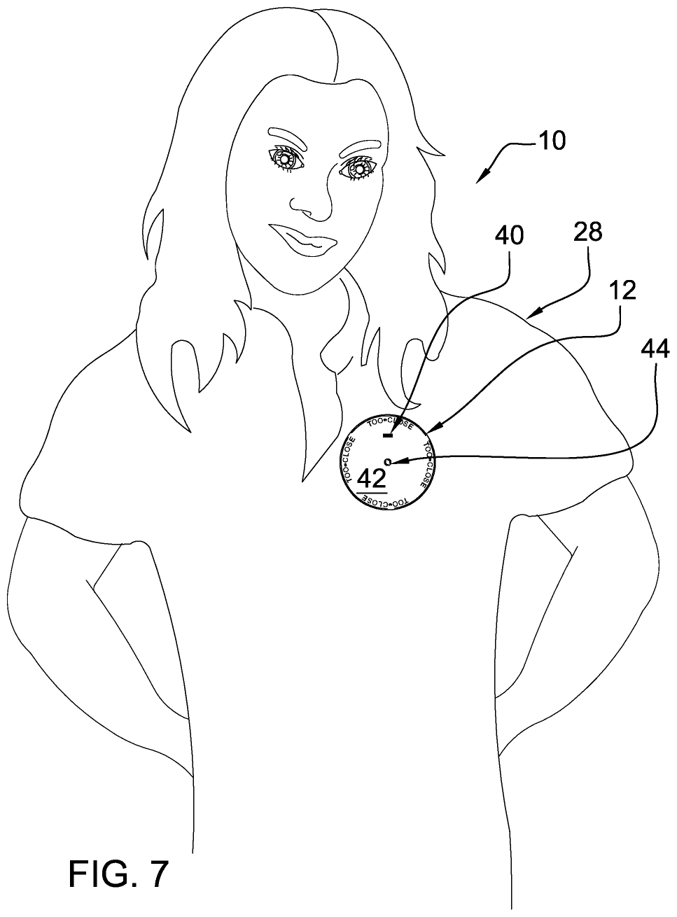

With reference now to the drawings, and in particular to FIGS. 1 through 7 thereof, a new sensing and alerting device embodying the principles and concepts of an embodiment of the disclosure and generally designated by the reference numeral 10 will be described.

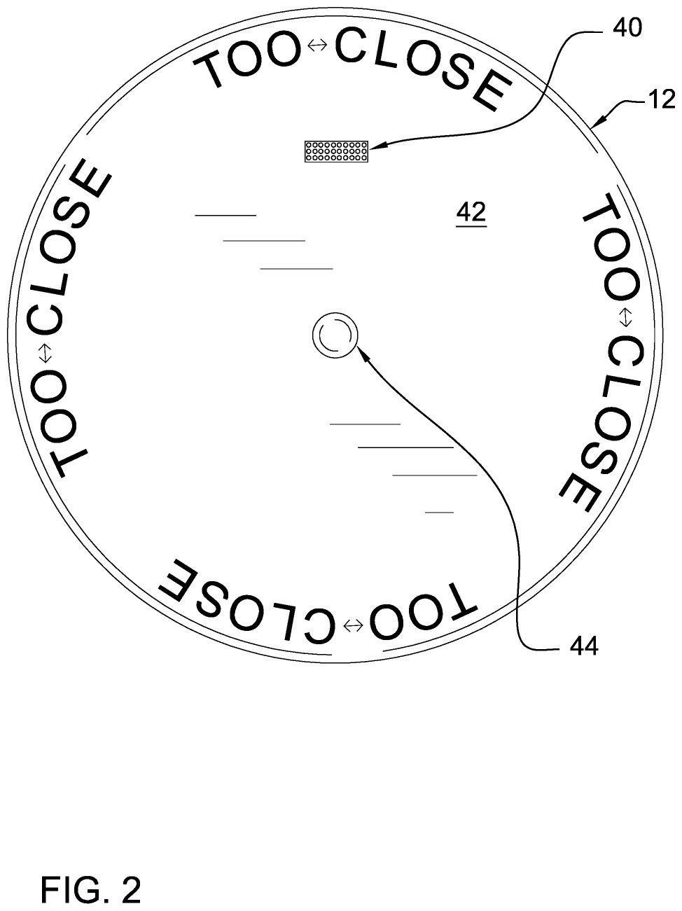

As best illustrated in FIGS. 1 through 7, the body worn proximity sensing and alerting device 10 generally comprises a housing 12, which defines an interior space 14. The housing 12 may be disc shaped, as shown in FIG. 2, or alternatively shaped, such as square, triangular, and the like. A fastener 16 is engaged to a first face 18 of the housing 12 and is configured to selectively engage a user so that the housing 12 is removably engaged to the user.

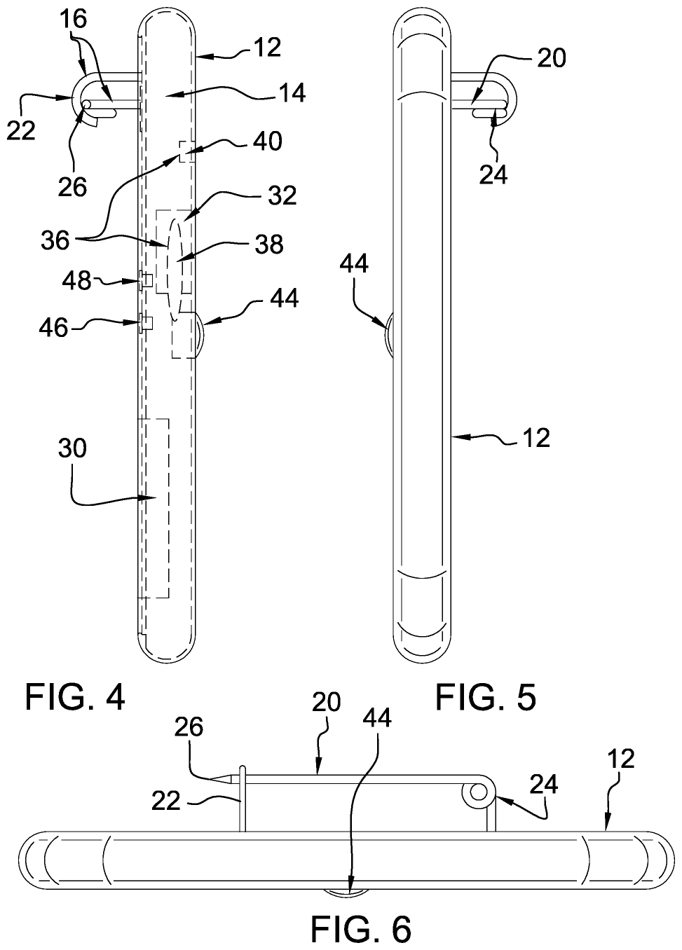

The fastener 16 may comprise a pin 20 and a hook 22, as shown in FIGS. 4-6, or other fastening means, such as, but not limited to, pressure sensitive adhesives, hook and loop fasteners, and the like. The pin 20 is hingedly engaged to the housing 12 by a first end 24 of the pin 20. The hook 22 is engaged to and extends from the housing 12. A second end 26 of the pin 20 is configured to penetrate a pleat in an article of clothing 28. The term pleat is not intended to imply only a permanent pleat, but also a temporary pleat created by pinching the article of clothing 28. The hook 22 then is positioned to selectively engage the pin 20, proximate to the second end 26, to removably engage the housing 12 to the article of clothing 28.

A battery 30 and a microprocessor 32 are engaged to the housing 12 and are positioned in the interior space 14. The microprocessor 32 is operationally engaged to the battery 30. The battery 30 may be rechargeable, although the present invention also anticipates the battery 30 be replaceable. A port 34 is engaged to the housing 12 and is operationally engaged to the battery 30. The port 34 is configured to selectively engage a plug of a charging cord (not shown) to operationally engage the battery 30 to a source of electrical current to charge the battery 30.

An alert module 36 is engaged to the housing 12 and is communicatively engaged to the microprocessor 32. The alert module 36 comprises one or both of a vibrator 38 and a speaker 40, or other alerting means, such as, but not limited to, lights, alarms, and the like. The vibrator 38 is engaged to the housing 12 and is positioned in the interior space 14. The vibrator 38 is communicatively engaged to the microprocessor 32 so that the microprocessor 32 can selectively actuate the vibrator 38 to provide a vibratory alert to the user. The speaker 40 is engaged a second face 42 to the housing 12 and is communicatively engaged to the microprocessor 32 so that the microprocessor 32 can selectively actuate the speaker 40 to provide an audible alert to the user.

A sensor 44 is engaged to the second face 42 of the housing 12 and is communicatively engaged to the microprocessor 32. The sensor 44 is configured for proximity detection, for example, by passive infrared sensing, and to communicate a detection event to the microprocessor 32. The microprocessor 32 selectively actuates the alert module 36, which is configured to alert to the user of the detection event, thereby facilitating the user in maintaining their personal space and distance from others.

A first switch 46 and a second switch 48 are engaged to the first face 18 of the housing 12 and are communicatively engaged to the microprocessor 32. The first switch 46 and the second switch 48 are configured to be selectively switched to signal the microprocessor 32 to selectively actuate the vibrator 38 and the speaker 40, respectively, upon communication of a detection event to the microprocessor 32 by the sensor 44, to provide to the user a vibratory alert and an audible alert, respectively.

The present invention also anticipates controlling means (not shown) to set a range of sensing for the sensor 44. For example, the controlling means could be used to set a range for the sensor 44 of 10 feet, 6 feet, or 3 feet.

In use, the fastener 16 is used to affix the housing 12 to an article of clothing 28 positioned on a user. When the sensor 44 senses another person in proximity to the user, a detection event is communicated to the microprocessor 32 so that the microprocessor 32 selectively actuates the alert module 36 to alert the user of the detection event. The user may elect to utilize multiple body worn proximity sensing and alerting devices 10, perhaps on a front and rear of the article of clothing, to sense persons in a broader area around the user.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A body worn proximity sensing and alerting device:
a housing defining an interior space, the housing comprising a first face and a second face opposite the first face;
a fastener engaged to the first face of the housing and configured for selectively engaging a user, such that the housing is removably engaged to the user,
wherein the fastener comprises:
a pin having a first end hingedly engaged to the housing; and
a hook engaged to and extending from the housing, wherein a second end of the pin is configured for penetrating a pleat in an article of clothing, such that the hook is positioned for selectively engaging the pin proximate to the second end for removably engaging the housing to the article of clothing with the second face of the housing being directed towards the user;
a battery engaged to the housing and positioned in the interior space;
a microprocessor engaged to the housing and positioned in the interior space, the microprocessor being operationally engaged to the battery;
an alert module engaged to the housing and communicatively engaged to the microprocessor, the alert module comprising a speaker being engaged to the second face of the housing and communicatively engaged to the microprocessor such that the microprocessor can selectively actuate the speaker for providing an audible alert to the user, the speaker being configured to project the audible alert away from the second face; and
a sensor engaged to the second face of the housing and communicatively engaged to the microprocessor, the sensor being configured for proximity detection and for communicating a detection event to the microprocessor, such that the microprocessor selectively actuates the alert module, wherein the alert module is configured for alerting to the user of the detection event.

2. The body worn proximity sensing and alerting device of claim 1, wherein the housing is disc shaped.

3. (canceled)

4. The body worn proximity sensing and alerting device of claim 1, further including:
the battery being rechargeable; and
a port engaged to the housing and being operationally engaged to the battery, wherein the port is configured for selectively engaging a plug of a charging cord for operationally engaging the battery to a source of electrical current for charging the battery.

5. The body worn proximity sensing and alerting device of claim 1, wherein the alert module further comprises a vibrator being engaged to the housing and positioned in the interior space, the vibrator being communicatively engaged to the microprocessor, such that the microprocessor can selectively actuate the vibrator for providing a vibratory alert to the user.

6. The body worn proximity sensing and alerting device of claim 1, wherein the sensor is configured for passive infrared sensing.

7. The body worn proximity sensing and alerting device of claim 5, further including:
a first switch engaged to the first face of the housing, the first switch being communicatively engaged to the microprocessor, wherein the first switch is configured for being selectively switched for signaling the microprocessor for selectively actuating the vibrator, upon communication of a detection event to the microprocessor by the sensor, for providing a vibratory alert to the user; and
a second switch engaged to the first face of the housing, the second switch being communicatively engaged to the microprocessor, wherein the second switch is configured for being selectively switched for signaling the microprocessor for selectively actuating the speaker, upon communication of a detection event to the microprocessor by the sensor, for providing an audible alert to the user,
wherein the first switch and the second switch cooperatively select one of a plurality of operational modes for the microprocessor, the plurality of operational modes comprising an off mode, a vibration alert mode, an audible alert mode, and a combination vibration and audible alert mode.

8. A body worn proximity sensing and alerting system:
an article of clothing positioned on a user;
a housing defining an interior space, the housing comprising a first face and a second face opposite the first face;
a fastener engaged to the first face of the housing and to the article of clothing, such that the housing is engaged to the article of clothing, wherein the fastener comprises:
a pin having a first end hingedly engaged to the housing; and
a hook engaged to and extending from the housing, wherein a second end of the pin is configured for penetrating a pleat in an article of clothing, such that the hook is positioned for selectively engaging the pin proximate to the second end for removably engaging the housing to the article of clothing with the second face of the housing being directed towards the user;
a battery engaged to the housing and positioned in the interior space;
a microprocessor engaged to the housing and positioned in the interior space, the microprocessor being operationally engaged to the battery;
an alert module engaged to the housing and communicatively engaged to the microprocessor, the alert module comprising a speaker being engaged to the second face of the housing and communicatively engaged to the microprocessor such that the microprocessor can selectively actuate the speaker for providing an audible alert to the user, the speaker being configured to project the audible alert away from the second face; and
a sensor engaged to the second face of the housing and communicatively engaged to the microprocessor, the sensor being configured for proximity detection and for communicating a detection event to the microprocessor, such that the microprocessor selectively actuates the alert module, wherein the alert module is configured for alerting to the user of the detection event.

9. The body worn proximity sensing and alerting system of claim 8, wherein the housing is disc shaped.

10. (canceled)

11. The body worn proximity sensing and alerting system of claim 8, further including:
the battery being rechargeable; and
a port engaged to the housing and being operationally engaged to the battery, wherein the port is configured for selectively engaging a plug of a charging cord for operationally engaging the battery to a source of electrical current for charging the battery.

12. The body worn proximity sensing and alerting system of claim 8, wherein the alert module further comprises a vibrator being engaged to the housing and positioned in the interior space, the vibrator being communicatively engaged to the microprocessor, such that the microprocessor can selectively actuate the vibrator for providing a vibratory alert to the user.

13. The body worn proximity sensing and alerting system of claim 8, wherein the sensor is configured for passive infrared sensing.

14. The body worn proximity sensing and alerting system of claim 12, further including:
a first switch engaged to the first face of the housing, the first switch being communicatively engaged to the microprocessor, wherein the first switch is configured for being selectively switched for signaling the microprocessor for selectively actuating the vibrator, upon communication of a detection event to the microprocessor by the sensor, for providing a vibratory alert to the user; and
a second switch engaged to the first face of the housing, the second switch being communicatively engaged to the microprocessor, wherein the second switch is configured for being selectively switched for signaling the microprocessor for selectively actuating the speaker, upon communication of a detection event to the microprocessor by the sensor, for providing an audible alert to the user,
wherein the first switch and the second switch cooperatively select one of a plurality of operational modes for the microprocessor, the plurality of operational modes comprising an off mode, a vibration alert mode, an audible alert mode, and a combination vibration and audible alert mode.

15. A body worn proximity sensing and alerting device:
a housing defining an interior space, the housing comprising a first face and a second face opposite the first face, the housing being disc shaped;
a fastener engaged to the first face of the housing and configured for selectively engaging a user, such that the housing is removably engaged to the user, the fastener comprising a pin and a hook, the pin having a first end hingedly engaged to the housing, the hook being engaged to and extending from the housing, wherein a second end of the pin is configured for penetrating a pleat in an article of clothing, such that the hook is positioned for selectively engaging the pin proximate to the second end for removably engaging the housing to the article of clothing with the second face of the housing being directed towards the user;
a battery engaged to the housing and positioned in the interior space, the battery being rechargeable;
a port engaged to the housing and being operationally engaged to the battery, wherein the port is configured for selectively engaging a plug of a charging cord for operationally engaging the battery to a source of electrical current for charging the battery;
a microprocessor engaged to the housing and positioned in the interior space, the microprocessor being operationally engaged to the battery;
an alert module engaged to the housing and communicatively engaged to the microprocessor, the alert module comprising:
a vibrator being engaged to the housing and positioned in the interior space, the vibrator being communicatively engaged to the microprocessor, such that the microprocessor can selectively actuate the vibrator for providing a vibratory alert to the user; and
a speaker being engaged the second face to the housing and communicatively engaged to the microprocessor such that the microprocessor can selectively actuate the speaker for providing an audible alert to the user, the speaker being configured to project the audible alert away from the second face;
a sensor engaged to the second face of the housing and communicatively engaged to the microprocessor, the sensor being configured for proximity detection and for communicating a detection event to the microprocessor, such that the microprocessor selectively actuates the alert module, wherein the alert module is configured for alerting to the user of the detection event, the sensor being configured for passive infrared sensing;
a first switch engaged to the first face of the housing, the first switch being communicatively engaged to the microprocessor, wherein the first switch is configured for being selectively switched for signaling the microprocessor for selectively actuating the vibrator, upon communication of a detection event to the microprocessor by the sensor, for providing a vibratory alert to the user; and
a second switch engaged to the first face of the housing, the second switch being communicatively engaged to the microprocessor, wherein the second switch is configured for being selectively switched for signaling the microprocessor for selectively actuating the speaker, upon communication of a detection event to the microprocessor by the sensor, for providing an audible alert to the user,
wherein the first switch and the second switch cooperatively select one of a plurality of operational modes for the microprocessor, the plurality of operational modes comprising an off mode, a vibration alert mode, an audible alert mode, and a combination vibration and audible alert mode.
